(19) United States
(12) Patent Application Publication
(10) Pub. No.: US 2026/0342867 A1
(43) Pub. Date: Oct. 29, 2026

(54) DISTRIBUTED SYSTEM FOR DATA STREAM CONTENT ANALYSIS AND FILTERING

(71) Applicant: BAYLOR UNIVERSITY, Waco, TX (US)

(72) Inventors: Andrew C. Freeman, Waco, TX (US); Greg Speegle, Waco, TX (US)

(73) Assignee: BAYLOR UNIVERSITY, Waco, TX (US)

(21) Appl. No.: 19/655,943

(22) Filed: Apr. 23, 2026

Related U.S. Application Data
(60) Provisional application No. 63/793,022, filed on Apr. 23, 2025.

(51) Int. Cl. H04L 65/75; G06F 16/55; G06F 16/583; H04L 69/40

(52) U.S. Cl. CPC H04L 65/75; G06F 16/55; G06F 16/583; H04L 69/40

(57) ABSTRACT

A system for distributed data analysis and filtering, comprising a publisher system operating on a processor and configured to transmit a data stream comprising a plurality of groups of data to a relay system over a stateful transport protocol, and the relay system operating on a processor and configured to receive the plurality of groups from the publisher, forward each group to one or more analyzer subscribers and selectively forward each group to one or more filtering subscribers based on one or more approval messages received from the one or more analyzer subscribers.

### RELATED APPLICATIONS

This application claims benefit of and priority to U.S. Provisional Patent Application No. 63/793,022, filed Apr. 23, 2025, which is hereby incorporated by reference for all purposes as if set forth herein in its entirety.

### TECHNICAL FIELD

The present disclosure relates generally to data streaming, and more specifically to systems and methods for data stream content analysis and filtering.

### BACKGROUND OF THE INVENTION

Analysis of content is typically performed offline on centralized servers and is challenging for audiovisual content, live content and other types of data.

### SUMMARY OF THE INVENTION

A system for distributed data analysis and filtering is disclosed that includes a publisher system operating on a processor and configured to transmit a data stream comprising a plurality of groups of data to a relay system over a stateful transport protocol. The relay system operates on a processor and is configured to receive the plurality of groups from the publisher, forward each group to one or more analyzer subscribers and selectively forward each group to one or more filtering subscribers based on one or more approval messages received from the one or more analyzer subscribers.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for a distributed content filtering system, in accordance with an example embodiment of the present disclosure;

FIG. 2 is a diagram of a system for processing images, in accordance with an example embodiment of the present disclosure;

FIG. 3 is a diagram of a system for real-time live stream moderation based on the MoQ protocol, in accordance with an example embodiment of the present disclosure;

FIG. 4 is a diagram of a system for processing image data at a first stage, in accordance with an example embodiment of the presence disclosure;

FIG. 5 is a diagram of a system for processing image data at a second stage, in accordance with an example embodiment of the present disclosure;

FIG. 6 is a diagram of a system for processing image data at a third stage, in accordance with an example embodiment of the present disclosure;

FIG. 7 is a diagram of a system for processing image data at a fourth stage, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Live video streaming is increasingly popular on social media platforms. With the growth of live streaming comes an increased need for robust content moderation to remove dangerous, illegal, or otherwise objectionable content. Whereas video on demand distribution enables offline content analysis, live streaming imposes restrictions on latency for both analysis and distribution. This disclosure provides systems and methods that can be used to implement extensions to the in-progress Media Over QUIC (MOQ) Transport protocol that enable real-time content moderation in both one-to-many video live streams and video on demand (VOD) streams. The systems and methods only remove the video segments that contain objectionable content, allowing playback resumption as soon as the stream conforms to content policies again. The systems and methods are implemented and evaluated in the context of light strobe removal for photosensitive viewers, as well as evidence that streaming clients experience an increased latency of only one group-of-pictures duration.

In 2023, live streaming constituted 18% of all downstream Internet traffic in the Americas. Although some of this traffic is in traditional media such as sports and news, live streaming content is dominated by social media platforms such as YouTube, Twitch, Facebook, Instagram, X, and TikTok. For example, TikTok reported that more than 100 million of its users created a live stream in 2024. Whereas government bodies such as the Federal Communications Commission regulate what content is permissible on broadcast television, there is much less oversight for Internet-based platforms. Indeed, the massive scale of user-generated live stream content is impossible to police through manual means.

Video streaming platforms can benefit from systems and methods that detect and mitigate risks such as explicit content, violence, illegal acts, and photosensitivity triggers. Many of these risks can be detected through existing offline analysis pipelines for VoD content. Then, a platform can simply block the publication or visibility of an entire video if it contains objectionable content. In the live context, however, a video platform must analyze a stream in real time, blocking it only when the objectionable content begins.

Dominant streaming solutions such as HTTP Live Streaming (HLS) and Dynamic Adaptive Streaming over HTTP (DASH) have “Low-Latency” (LL) extensions for live streaming in LL-HLS and LL-DASH, respectively. These existing systems are generally stateless, meaning that clients determine the data they receive by issuing specific HTTP GET requests. The servers likewise cannot easily choose which data to make available for any individual client.

Meanwhile, MoQ is a protocol draft aimed at improving the latency of live video delivery. MoQ is stateful, giving servers the power to determine exactly what data any particular client can receive. Stateful streaming with MoQ can greatly improve the flexibility of content moderation tools, allowing content to be selectively blocked with user-specific criteria. For example, video segments depicting alcohol or tobacco use can be blocked for underage viewers, but still be transmitted to adult viewers.

The present disclosure examines the current design of MoQ for live video streaming and proposes extensions for dynamic content filtering with distributed content analysis. An example system implementation is evaluated with a toy “light strobe” detection application for photosensitive viewers. It is demonstrated that the analysis step can delay the delivery of approved content by only the duration of a single group-of-pictures. The steps to incorporate rate adaptation and server-driven task distribution are also identified.

The most common video streaming protocols today are HLS and DASH, falling under the umbrella of HTTP Adaptive Streaming (HAS). These protocols operate by dividing a source video file into temporal segments, and these segments are catalogued in a manifest file. A segment typically maps to a group of pictures (GOP), an independently decodable time range of the video. The manifest and source video files are made available on an HTTP server. To receive video data, a streaming client first issues a GET request for the manifest. The manifest provides the necessary information for subsequent GET request to retrieve each desired segment of the video. These protocols support adaptation through indexing multiple representations of a video at different bitrates. Based on network congestion, a client can lower or increase the bitrate by simply changing the target representation in the GET request for the next segment.

Live streaming variants of these protocols (LL-HLS and LL-DASH) operate on much the same principle, but with some modifications for low-latency updates. Video segments are further which divided into multiple “chunks,” are smaller file representations corresponding to a handful of image frames, rather than an entire GOP. This chunking process allows the client to retrieve (and begin decoding) a new GOP before the entire GOP has been written to the HTTP server. Live-oriented HTTP adaptive streaming (HAS) protocols increase the communication overhead compared to VoD, because clients must issue more frequent GET requests to retrieve dynamic manifest updates and sub-segment chunks.

MoQ is a work-in-progress protocol being developed through the Internet Engineering Task Force (IETF) and primarily aims to improve the latency and bandwidth requirements for live stream video delivery. MoQ Transport (MoQT) is the core document in the MoQ protocol draft. The MoQT specification defines the data entities, header formats, and control signals of the transport protocol. A brief summary of the components from MoQT that are relevant to this disclosure is provided. Although MoQT is a generic transport protocol, for this disclosure terminology specific to video streaming is used.

MOQ uses a publisher/subscriber model. Data are communicated from a publisher to a relay. A relay then manages sessions for publishers and subscriber(s), forwarding the data to each subscriber as they are made available. Connections are maintained through QUIC or WebTransport streams, unlocking push-based media delivery. The protocol draft does not specify how a relay may or may not allow interaction between different subscriber sessions.

Stream adaptation is made possible through Tracks, which contain independent data streams. A client can, for example, subscribe to a high-bitrate video Track when it has a strong connection, then replace its subscription with a low-bitrate Track when it encounters network congestion. Tracks carry Groups, which are typically independently decodable units of data. In video streaming, a Group commonly maps to a GOP in an encoded video. A Group consists of one or more Objects, which map to individual video frames. Subscribers can set the priority of each subscription, which determines how the relay will deliver data during periods of congestion. For example, a client can set an audio Track subscription to have a higher priority than a video Track. The Web Application Real-time Protocol (WARP) stream format can be used to standardize the mechanisms for MoQ-based video adaptation.

Objectionable video content can fall into at least three classes: 1) content that poses a risk to health; 2) content that is illegal; and 3) content that is offensive.

For health risks, an important health-related issue with video content is the potential to cause seizures. There are more than 100,000 Americans with “photosensitive epilepsy” (PSE), a condition that increases the risk for seizures when individuals are subjected to certain light stimuli. These stimuli include rapidly flashing lights or colors and high-contrast patterns. There are several guidelines for mitigating PSE risks in video content production, and these guidelines have driven the development of both direct and learned methods for PSE risk detection. Previous works mainly perform PSE risk detection offline, and risks are mitigated by modifying a video itself (e.g., by reducing contrast). In the context of HAS, such methods would require transcoding to produce a PSE-safe video representation. To our knowledge, no social media platform has implemented PSE-safe transcoding in their video streaming pipelines. In 2020, however, TikTok introduced an accessibility option that disables the playback of videos determined to be PSE risks through. This feature appears to apply only to VoD, rather than TikTok's live service.

Some filtering topics are considered illegal in nearly all jurisdictions, including depictions of child exploitation and sexual assault, and the distribution of pirated materials. Social media platforms leverage a combination of automated analysis, human moderators, and user reporting to police their video libraries for illegal content. However, one should consider that the illegality of content can depend on the age and location of the viewer. For example, a country can prohibit the depiction of smoking or alcohol usage for minors. To support such blocking in traditional adaptive streaming systems, a platform must block access to the stream data at the application layer. For large-scale live streaming, the computational burden makes real-time content analysis difficult. Platforms such as Twitch thus rely heavily on human moderation for these streams. If a live stream is deemed to contain any illegal content, it is wholly blocked for all users.

Finally, content might not necessarily be illegal but can be offensive to some users. Social media platforms often impose their own restrictions, such as prohibiting violence, drugs, gambling, or pornography. Again, in HAS live streaming, moderation of these topics is not done in real time. If a stream publisher begins filming offensive content during a stream, several minutes can pass before a stream is blocked by the platform's moderators (if it is blocked at all).

Furthermore, there is no mechanism on social video platforms for individual users to dictate which specific topics they want to block in live streams. This is particularly an issue for parental control, as different sets of parents can have dramatically different views on what content is appropriate for their children.

A live streaming system is disclosed where each end user can choose precisely what content they want to block from their received stream. This system can support filtering a variety of user-selected content categories and have a minimal impact on stream latency. It can bring about improvements to stream accessibility, safety, and personalization for users worldwide.

With traditional HAS protocols, an analysis pipeline can only be deployed on the live stream ingest server. The server could continually add metadata to the manifest file (e.g., with DASH EventStream tags) to indicate where certain content categories are (or are not) detected. The major downside to this approach is the increase in latency for all clients. For each new segment, every client fetches the updated manifest file. The client then would check to see if its filter categories have completed analysis and been approved. If some filter categories are still under analysis, the client must poll the server continually until they are complete. These polling requests, however, will invariably increase the end-to-end latency: either the server will slow down due to the frequent requests, or request rates will be throttled. The overhead of pull-based media delivery thus makes such a system impractical. Push-based delivery can effectively minimize overhead, reduce latency, and increase the granularity of user personalization.

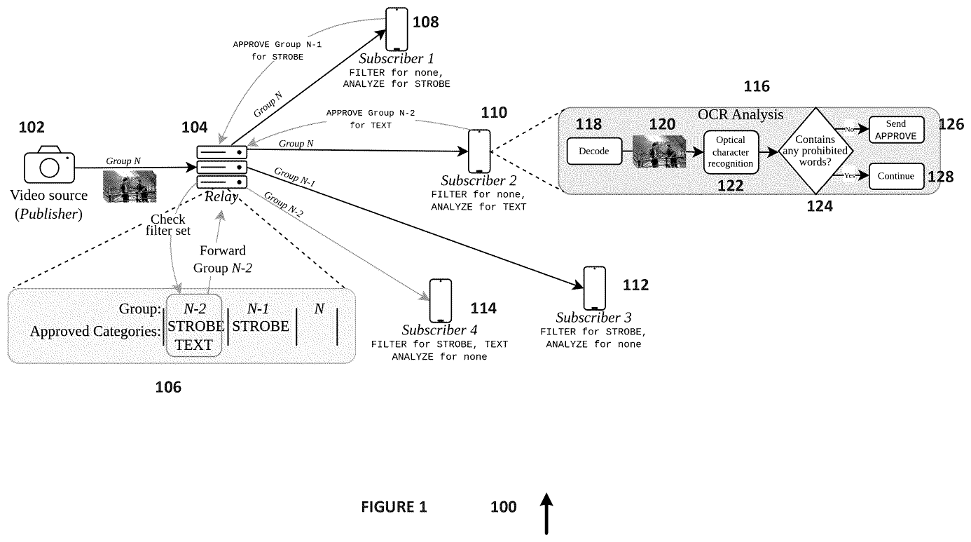

The disclosed modifications to an MoQ live streaming system enable dynamic content filtering. One or more subscribers are designated as “analyzers.” An analyzer client decodes each Group it receives and runs the frames through a computer vision analysis pipeline. The goal of the analysis is to determine if the Group contains any material that should be blocked for other subscribers. If the analyzer determines that the Group does not contain any objectionable material, it notifies the relay that the Group is acceptable. When the relay receives this message, it then transmits that Group to all downstream subscribers that are awaiting the approval, as shown in FIG. 1.

A client initiates an MoQ subscription by issuing a SUBSCRIBEcontrol message to the relay, containing information such as the track identifiers and the priority. A client can modify an existing subscription by issuing a SUBSCRIBE-UPDATE control message. In both cases, the draft specification allows for a number of optional “parameters” at the end of these messages for additional functionality. For example, a client can include a DELIVERY_TIMEOUT parameter to set the maximum latency between an Object arriving at the relay and being sent to the subscriber.

For the disclosed system, two new MoQT parameters are provided: ANALYZE and FILTER. Both parameters include a variable number of “categories.” A subscriber issues an ANALYZE parameter in a SUBSCRIBE-based message if it wants to perform certain content analyses on the received stream. If the relay accepts this request, then that subscriber is referred to as an “analyzer” for those categories of analysis. Similarly, a subscriber issues a FILTER parameter if it wants to only receive a Group once it has been approved by an analyzer for the requested categories. The only difference between ANALYZE and FILTER is the parameter Type. Both can contain a variable number of Categories, such as STROBE, SMOKING, and ALCOHOL. An example structure for parameters is provided in Listing 1 below, where “(i)” indicates that the data type is a variable-length integer, as in the protocol draft, but other suitable embodiments can also or alternatively be used.

```
ANALYZE/ FILTER P a r a m e t e r
                                        {
    P a r a m e t e r Type ( i ) = 0 x05 / 0 x06
    P a r a m e t e r Length ( i )
    P a r a m e t e r Value = C a t e g o r i e s { {
      C a t e g o r i e s Length ( i )
      Number of C a t e g o r i e s ( i )
      [
        C a t e g o r y Type ( i ) ,
        C a t e g o r y Type ( i ) ,
        . . .
      ]
    }
  }
```

Listing 1: Format for the ANALYZE and FILTER parameters. If a client ANALYZES some Categories, it will examine each Group for the presence of those materials. If a client FILTERS some Categories, it will only receive a Group if it does not contain any of those materials.

Once an analyzer subscriber has finished processing a Group, it issues an APPROVE control message. This message carries the subscription and Group identifiers (IDs), and the Categories that have been approved. If the subscriber is an analyzer for multiple Categories, it is possible that only a subset of them can be APPROVED. If there are no approved Categories, the subscriber can avoid sending an APPROVE message entirely. An example format of this control message is provided in Listing 2, but other suitable embodiments can also or alternatively be used.

```
APPROVE Message {
    Type ( i ) = 0 x41 ,
      Length ( i ) ,
      S u b s c r i b e ID ( i ) ,
      Group ID ( i ) ,
      C a t e g o r i e s {
          C a t e g o r i e s Length ( i )
          Number of C a t e g o r i e s ( i )
          [
            C a t e g o r y Type ( i ) ,
            C a t e g o r y Type ( i ) ,
            . . .
        ]
    }
  }
```

Listing 2: Format for the APPROVE message. An analyzer client can report on one or more Categories, and an APPROVE message indicates that the Group does not contain the material conveyed by those Categories.

FIG. 1 is a diagram of a system 100 for a distributed content filtering system, in accordance with an example embodiment of the present disclosure. System 100 includes video source 102, relay 104, processing system 106, subscriber 1 108, subscriber 2 110, subscriber 3 112, subscriber 4 114, processing system 116, decoder 118 image data 120, optical character recognition 122, decision block 124, approval block 126 and continue 128, each of which can be implemented in hardware or a suitable combination of hardware and software. In one example embodiment, each system can be implemented as one or more lines of code that are loaded into the working memory of a processor that causes the processor when executed to perform the functions discussed below.

Video source 102 generates groups N of image data and provides the image data to relay 104. While “video data” or “image data” is used in example embodiments, a person of skill in the art will recognize that the disclosed systems and processes can also or alternatively be used for audio data, audiovisual data, packetized data for artificial intelligence or other suitable data. Relay 104 uses processing system 106 to store groups and associated categories, such as a category of STROBE and TEXT for Group N−1, a category of STROBE for Group N−1 and to process Group N. Subscriber 1 108 can be approved by relay 104 for analyzing Group N−1 for STROBE and filtering none. Subscriber 2 110 can be approved by relay 104 for analyzing Group N−2 for TEXT and filtering none. Subscriber 3 112 can be approved by relay 104 to filter Group N−1 for STROBE and to analyze none. Subscriber 4 114 can be approved by relay 104 to filter Group N−2 for STROBE and TEXT and to analyze none. Processing system 116 can be used by subscriber 2 110 to decode 118 image data 120, to perform optical character recognition 122, and to use decision block 124 to select approval block 126 or continue 128.

Analysis tasks can transparently be distributed to both servers such as subscriber 1 108 and user devices such as subscriber 2 110 with the same MoQ mechanisms. Relay 104 can be configured to coordinate analyzer clients and the appropriate delivery of Groups. In one embodiment, relay 104 can send a Group to a subscriber if and only if all of the subscriber's FILTER Categories have been APPROVED for that group by other subscribers. A subscriber might not have both ANALYZE and FILTER mechanisms enabled, as otherwise it would not be able to analyze groups that are blocked by its filter Category. System 100 demonstrates the additional latency incurred through FILTERING, such as where subscriber 3 112 must wait for Group N−1 to be analyzed by both subscriber 1 108 and subscriber 2 110. Since these processes can run concurrently, subscriber 3 112 incurs the latency of whichever ANALYZE connection is the slowest. Meanwhile, the newest group in the source live stream is Group N, which is one GOP duration ahead.

The disclosed system can use the moq-rs Rust repository available at https://github.com/moq-dev/moq. Although this repository technically tracks a fork of the core MoQ draft, the fundamental mechanisms are not significantly different from the mainline protocol, and the proposed system can be implemented for other reference software. An example analysis application for this application implements a toy light strobe detection system in the Web player using Rust for WebAssembly. The disclosed application takes a uniform pixel sample of the luminosity (Y) channel of two consecutive YUV image frames. It evaluates the − brightness difference of these samples, and compares it to a tunable threshold value. If a substantial portion of the samples have increased in brightness beyond the threshold, the frame is a significant brightness change. If there are at least two such change images during a short period of time (representing a strobe interval of at least 10 Hz), then the Group is classified as a strobe risk. Otherwise, the subscriber issues an APPROVE message for the Group, indicating that it does not pose a substantial risk for photosensitive viewers. System 200 illustrates the flow of this analysis pipeline. In the disclosed web player, an HTML button toggle is included for a subscriber's status as an analyzer. When a user presses the button, the client sends a SUBSCRIBE_UPDATE control message with the appropriate ANALYZE parameter.

The transport reference code is amended to appropriately manage the Group delivery. Rather than deliver newly received Groups to all subscribers at once, the relay delivers them first to analyzer subscribers that have no FILTER Categories enabled. When an APPROVE message is received on an analyzer session, it is forwarded as a broadcast message on a Rust-based “multiple producer, multiple consumer” communication channel. All other active sessions on the relay wait to receive these messages, tracking which of their FILTER Categories have been APPROVED. Once all the Categories have been APPROVED for the given Group, the session finally delivers the Group to the subscriber. For simplicity, the Group IDs received by the relay are assumed to monotonically increase by one, but other suitable processes can also or alternatively be used. If a session receives the relevant APPROVE messages for some Group N, but does not receive all the APPROVE messages for Group N−1 it knows that Group N−1 has been rejected for some Category. This Group is silently skipped, without informing the subscriber. The APPROVED Groups are buffered in a queue for each session, to accommodate variations in latency.

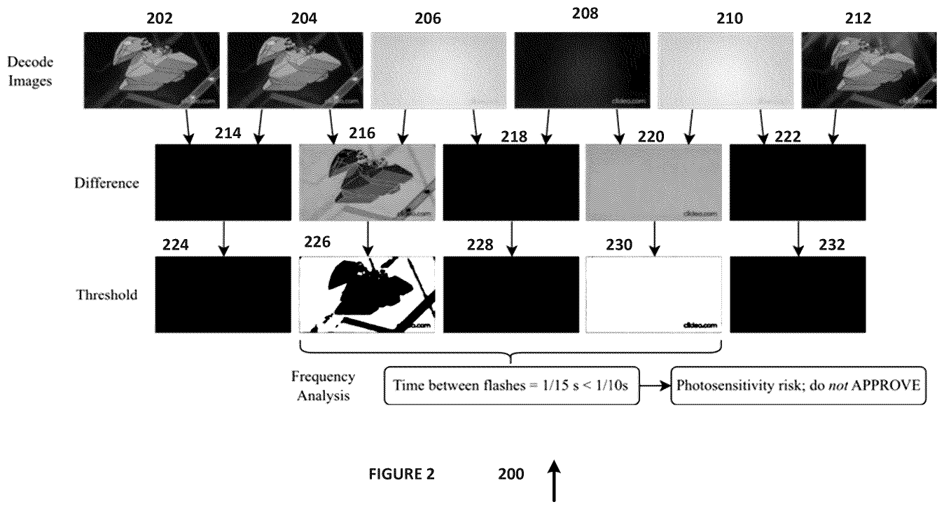

FIG. 2 is a diagram of a system 200 for processing images, in accordance with an example embodiment of the present disclosure. System 200 includes decode images 202 through 212, difference images 214 through 222 and threshold images 224 through 232, each of which can be generated using hardware or a suitable combination of hardware and software. Decode images 202 can be from the infamous Pokemon Episode 38, which was reported to have caused hundreds of children to experience epileptic seizures, and can be processed by a strobe detection application. In the disclosed system, this flashing strobe sequence can be filtered so that photosensitive viewers are not exposed to risk.

In one example embodiment, a live webcam feed was published to two separate web clients on a local machine. The GOP duration of the webcam stream was set to 1 second, and each GOP was organized into a separate Group. One client was set to ANALYZE light strobes, while the other was set to FILTER light strobes. Based on timestamp logs, the filtered subscriber consistently experienced 994-1005 milliseconds of additional latency compared to the analyzer, approximately matching the GOP duration. A strobing light impulse was then introduced to the camera feed, and it was observed that the playback on the filtered subscriber appeared to pause. In the background, the client stopped receiving new Groups until the impulse was removed.

This disclosed setup reflects what is expected to be the most common arrangement for these systems, where all content analysis is done on one or more servers, to minimize end-to-end latency. Less than 1 millisecond of propagation delay for both a Group to reach the subscriber, and for an APPROVE message to reach the relay and propagate to other sessions can be obtained. The analysis and control mechanisms can run on top of a standard MoQ subscriber. Therefore, the analysis load can be distributed to concurrent processes or even on the devices of end users, which can result in more energy-efficient and cost-effective streaming solutions when users have relaxed latency requirements.

An APPROVE message for Group N can be distributed to all sessions subscribed to any video track from the original publisher. That is, the presence of some objectionable content at one bitrate and resolution can preclude its dissemination at all other bitrates and resolutions.

A relay can send a SUBSCRIBE_UPDATE message to a subscriber with the ANALYZE parameter present (it is noted that a relay sourced SUBSCRIBE_UPDATE message is undefined behavior in the protocol draft). Additionally, the client and relay can exchange information about their supported analysis Categories during the session setup. This information can be added as parameters in the CLIENT_SETUP and SERVER_SETUP messages.

To improve the distribution of analysis tasks, the disclosed system can optionally employ REJECT control messages. These messages are conveyed from a client to a relay, and explicitly inform the relay that an analysis task has not been APPROVED. By using both APPROVE and REJECT control messages, the relay can monitor if an analysis task is taking too long to process a Group, based on configurable timeout. If the timeout threshold is exceeded, the relay can reallocate the analysis task to a different client, to prevent client stream starvation. An example format of this control message is provided in Listing 3, but other suitable embodiments can also or alternatively be used.

```
REJECT Message {
    Type ( i ) = 0 x42 ,
      Length ( i ) ,
      S u b s c r i b e ID ( i ) ,
      Group ID ( i ) ,
      C a t e g o r i e s {
          C a t e g o r i e s Length ( i )
          Number of C a t e g o r i e s ( i )
          [
            C a t e g o r y Type ( i ) ,
            C a t e g o r y Type ( i ) ,
            . . .
        ]
    }
  }
```

Listing 3: Format for the REJECT message. An analyzer client can report on one or more Categories, and a REJECT message indicates that the Group contains the material conveyed by those Categories.

If an embodiment supports adaptive bitrate streaming, the relay can distribute lower-bitrate versions to analysis clients. This process will enable faster transmission and processing, and allow clients with less powerful hardware to participate in distributed analysis.

In other potential embodiments, the analysis tasks may not be binary classifiers. The ANALYZE and FILTER parameter messages in Listing 1 can be extended to allow the user to specify a task-dependent threshold for each Category. The APPROVE and REJECT messages can similarly carry metadata about the exact application measurement of the analysis task. The relay can examine if a Group meets the threshold criteria on a client-specific basis, when deciding whether to forward the Group.

Any REJECT messages can also include metadata necessary for client-side image manipulation in cases where only a portion of the video frame contains offending material. For example, bounding box coordinates can be communicated to encompass the regions where violent acts are depicted. The client can receive these coordinates and selectively blur those spatial regions before displaying them to the user. In other potential embodiments, an analyzer client can perform this image manipulation and re-encode the Group. The resulting Group can be sent back to the relay for distribution to downstream clients.

The present disclosure thus standardizes the methods for distributing and validating analysis applications to client players, the wire format and behavior of our custom parameters and messages, and the dynamic distribution of analysis tasks among several clients.

Real-time moderation of user-generated live video is difficult to scale without harming overall latency or forcing one-size-fits-all policies. A distributed architecture is presented that leverages the MoQ Transport protocol to enable client-side content analysis and filtering with limited latency added only for the users with content filters enabled. Latency bounds for multi-relay propagation, failure handling, analyzer selection, and security risk mitigation are disclosed. Finally, accuracy-throughput tradeoffs and identify integration points with the WARP streaming format are outlined. Together, these contributions move video moderation toward personalized, low-latency content safety suitable for modern live streaming.

User-generated live video content has become a dominant mode of online entertainment and information sharing. However, as live streaming grows, moderating content at scale has become increasingly challenging. Traditional VOD streaming enables offline content analysis before publication, ensuring compliance with platform policies (e.g., violence, drugs, sexual content), albeit at the cost of significant delay. The latency demands of live video make automated analysis impractical in many cases. Often, human moderators are enlisted to perform manual content checks of popular streams.

The unidirectional, pull-based paradigm of traditional video streaming protocols (e.g., DASH and HLS) is a limiting factor to this content moderation problem. Specifically, all automated analysis must be performed server-side, increasing the latency for downstream users and preventing the use of user-specific content policies.

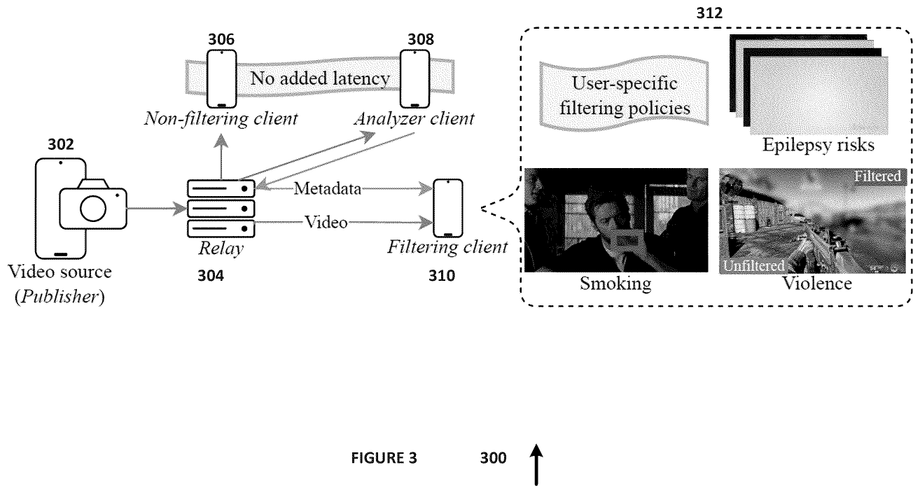

FIG. 3 is a diagram of a system 300 for real-time live stream moderation based on the MoQ protocol, in accordance with an example embodiment of the present disclosure. System 300 includes video source 302, relay 304, non-filtering client 306, analyzer client 308, filtering client 310 and data set 312, each of which can be implemented in hardware or a suitable combination of hardware and software. In one example embodiment, each system can be implemented as one or more lines of code that are loaded into the working memory of a processor that causes the processor when executed to perform the functions discussed below.

Video source 302 generates and transmits image data to relay 304, which provides the data to non-filtering client 306 and analyzer client 308 with no added latency. Filtering client 310 receives metadata and video that is processed with data set 312 that contains user-specific filtering policies for things like smoking, strobing, violence and so forth.

System 300 extends an MoQ live streaming framework to enable client-side content analysis and filtering with minimal added latency. It uses a publisher-subscriber model where analyzers inspect decoded video segments and send approval messages to a relay, which then forwards approved content to filtering clients. Multiple analyzer clients 308 and filtering clients 310 can be used and can operate concurrently, supporting diverse content categories and user-specific moderation policies. This distributed approach offloads moderation from delivery servers such as relay 304, allowing flexible filtering without adding latency for users who do not enable content filters. For users with filters enabled such as filtering client 310, the minimum added latency matches the duration of one group (e.g., 1 second). The efficacy of this approach is discussed with respect to a toy “strobe” detection application, which can be used to block dangerous flashing light sequences for users with PSE.

Multiple analyzer clients 308 and filtering clients 310 can also reduce the maximum filtering latency, and can be integrated with GPU-based image classification models. The MoQ-based communication scheme, Workflow Manager and Filter Decision Engine can be used to balance the tradeoff in analysis rate (to maintain low latency) and accuracy when running machine learning models on JavaScript edge clients. Session management and analysis task delegation as we increase the scale, redundancy, security, and fault tolerance of our distributed system. These developments move us closer to a flexible, scalable moderation system that empowers users with unprecedented control over their viewing experience, while offering video providers increased flexibility and reduced costs for moderation.

HAS systems such as DASH and HLS underpin large-scale video delivery by dividing media into segments and letting clients pull the next segments defined in a manifest file. Low-latency variants (LL-DASH and LL-HLS) further subdivide segments into short chunks to accelerate start-up and reduce live delay, but they preserve a request-response data flow that limits server-side control. Chunked packaging and tuned GOP sizes can improve tune-in and adaptive bit rate (ABR) responsiveness, yet the added request frequency and manifest polling introduce overhead.

The MoQT protocol aims to offer the scalability of HAS systems but with lower latency. MoQ is an IETF work-in-progress effort that introduces a stateful publish/subscribe transport atop QUIC/WebTransport with explicit relay support, stream prioritization, and an extensible control plane. MOQ models content as Tracks, Groups, and Objects and defines subscription messages and metadata extension headers. A Track typically corresponds to a particular representation or bitrate of a video. Each Track carries Groups, which are typically independently decodable GOPs. Each video Group carries several Objects, each of which is a video frame. Since MoQ itself is agnostic to the data payloads, however, arbitrary data can be packaged and sent within the Track/Group/Object semantics. The MoQT Streaming Format (MSF) specifies catalog signaling, packaging, and ABR switching on MoQT, targeting real-time and interactive regimes and using Low-Overhead Container (LOC) packaging. CMSF extends MSF to a Common Media Application Format (CMAF)-compliant mapping, aligning CMAF chunks/fragments to MoQ Objects/Groups and clarifying stream access point (SAP) semantics.

Content analysis and live moderation has historically relied on human moderators and post-hoc enforcement on social video platforms, with limited real-time automation. Therefore, there can be minutes-long gaps between policy violations and moderator action. Furthermore, moderation is typically a one-size-fits-all approach with binary classification, where a stream is either permitted on the service, or it is blocked entirely.

Edge application inference in browsers has matured through the Web Graphics Processing Unit (WebGPU) and Web Neural Network (WebNN) Application Programming Interfaces (APIs). WebGPU provides low-level GPU access through a JavaScript API, and the Open Neural Network Exchange (ONNX) runtime tailors WebGPU for AI inference. WebNN is a newer API undergoing standardization, and is tailored specifically for model inference by leveraging hardware-specific features across both GPUs and CPUs.

To overcome the limitations of existing live moderation pipelines, a system to distribute content analysis tasks to users' playback devices via the MoQT protocol is provided. MoQ's stateful, push-based transport can support live moderation by designating analyzers and gating delivery to filtering clients until approvals arrive for each GOP. The system leverages MoQT's session state and control messages to avoid manifest polling and to selectively filter only the offending video Groups, which is an improvement over coarse, whole-stream takedowns in conventional HAS pipelines. Selective blocking (e.g., strobe risks) with added latency of approximately GOP duration is provided, with no latency impact on non-filtering viewers. In addition, analyzer robustness and integrity is provided by avoiding single-analyzer decisions, which increase the risk of failure/compromise. Instead, multi-analyzer consolidation and quantification of correctness under adversarial rates is used. Because group-level classifications limit flexibility, a metadata track can be provided for per-frame filter actions (e.g., regions to blur). Furthermore, because single-relay configurations limit large-scale content delivery, a Workflow Manager and Filter Decision Engine for fail-over and redundancy across multi-relay topologies is provided that reduces latency by reusing upstream results. A multi-analyzer, per-frame, multi-relay system aligned with MoQ standardization efforts is provided that can deliver personalized, real-time content safety with bounded latency.

The disclosed system extends the core functionality of MoQ components. Publishers send video Groups/Objects to a relay, and subscribers receive video Groups/Objects from a relay. A subscriber can analyze the received content for moderation purposes, can choose to filter (e.g., block or blur) certain content, or can perform other suitable actions. Relays selectively forward video Groups/Objects to devices that are subscribed to the publisher's stream(s). A relay can include a Workflow Manager (WM) that delegates content analysis tasks to subscribers and a filter decision engine (FDE) that determines when to forward analysis results to downstream receivers.

An MoQ subscriber in the disclosed system can be a dedicated analysis server. Such subscribers can be useful for highly complex applications, to increase security, to mitigate latency or for other suitable functions.

The disclosed system can provide an option for granular, user-specific content policies, such as for strobing lights, violence, nudity, smoking and so forth. Each option can bring unique challenges for both detecting the content and filtering it. Strobing lights can cause seizure risks for users with PSE. A lightweight application to detect these risks can simply examine the frequency of brightness changes beyond a certain threshold. A user may want to block all frames from a strobe sequence, or to remove only the frames containing bright impulses. The latter strategy brings with it higher risk, in the case that the application fails to detect strobing frames, but it can yield a generally higher QoE because the user can experience a low-frame-rate stream with the bright frames removed.

Violence detection will typically require a multi-frame analysis and the use of a convolutional neural network (CNN) and recurrent neural network (RNN) or transformer-based classification model, requiring higher computational capacity. A strategy to filter violent content can involve a moderate blurring of all frames for the duration of the violent activity.

Smoking and nudity can be detected on a per-frame basis using a CNN. If an object detection model is used, the offending portion of each frame can be selectively blurred, leaving the rest of the image intact, as shown in system 300. The analysis applications themselves (e.g. model weights) can be distributed ahead of time to a subscriber. The blurring filter operations can be performed within the video player of a viewing client.

A subscriber can issue an ANALYZE MOQ Transport subscription parameter to volunteer as an “analyzer” for specified content categories and can perform analysis on received MoQ Groups. A relay can assign an analysis task to a client by adding the ANALYZE parameter to its SUBSCRIBE_OK response when the subscription begins, or to a SUBSCRIBE_UPDATE message for an existing subscription.

To communicate the analysis results, custom control messages can be sent from analyzer clients to the relay. Another approach is to leverage the existing Object Extension Headers in MOQT to store analysis results as frame-level metadata on each Object, which can require metadata duplication for the Frame Objects of different representations (i.e., bitrates/qualities). Dedicated filter metadata Tracks can also or alternatively be used, where an analyzer client can publish a metadata Track to send analysis results to its parent relay, and a relay can publish a metadata Track to downstream relays and filtering clients. A simplified example of this is shown in system 300.

A Filter Object can include a frame index corresponding to the set of video Frame Objects at a certain time, metadata for multiple content categories, and mark each as being present or absent in the Frame Object. Visually localized categories (e.g., smoking) can include additional coordinate metadata, which the clients can use to selectively blur part of the frame.

A FILTER subscription parameter can be used to inform a relay which content categories a client wants to be analyzed. The relay can push Frame Objects to the subscriber as normal, where the subscriber player does not show any received frame until it receives the corresponding Filter Objects for all the requested content categories. For integrity and availability purposes, redundant assignments of analysis tasks can be used across multiple subscribers. The relay can then be responsible for awaiting the Filter Object result message from each client, determining what the “true” result is, and forwarding it downstream. For each category in a subscriber's filter list, it can read the associated Filter Object metadata to determine how to display the decoded frame (e.g, leave unmodified, block, or blur).

The WM must efficiently coordinate various analysis tasks across many subscribers. For each stream session, the manager consolidates the Filter Objects received from all analyzers. The WM then handles important issues, such as characterizing the application. Analysis applications can have varying levels of computational complexity. For example, transformer-based models typically require more resources than CNNs. Furthermore, some applications such as action recognition require the analysis of several consecutive frames, slowing the overall inference time. The WM must therefore be provided with a coarse understanding of these tradeoffs for each provisioned application.

Another important issue is determining analyzer suitability. Each subscriber should periodically report its resource profile (e.g., computing capacity, available memory, storage, battery status) and network situation (e.g., throughput, latency) to the WM. When assigning analysis tasks, the WM should prioritize subscribers with low latency and high hardware resources.

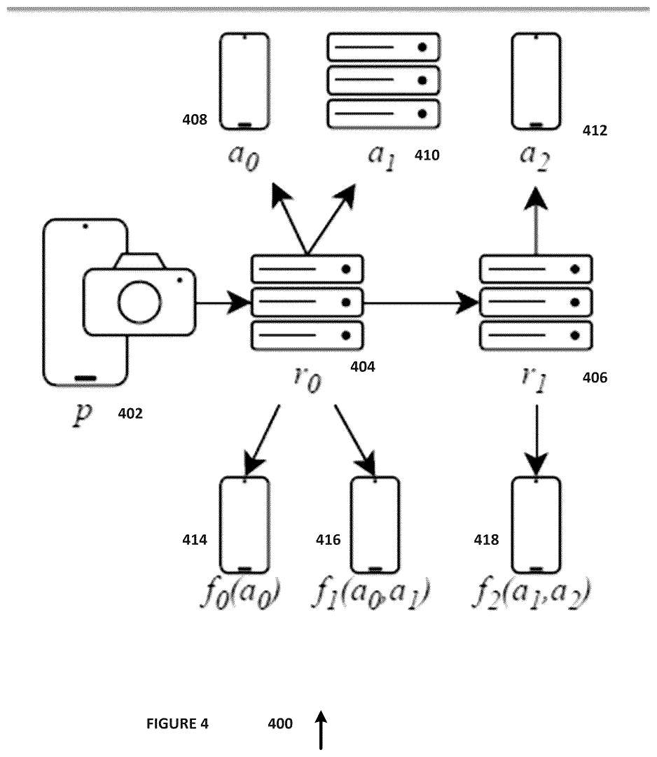

FIG. 4 is a diagram of a system 400 for processing image data at a first stage, in accordance with an example embodiment of the presence disclosure. System 400 includes source 402, router 404, client 408, router 406, router 410, client 412, client 414, client 416, and client 418.

Accommodating multiple relays is also important. An MoQ relay functions as a subscriber to upstream relays or source publishers. In large-scale content delivery, a real-world system can consist of many relays in a fan-out configuration, as shown in system 400 where source 402 is the publisher p, nodes r₀ and r₁ are relays, nodes a₀, a₁ and a₂ are analyzer clients, and nodes f₀, f₁ and f₂ are filter clients (with the selected filter categories noted in parentheses). Each relay can have its own independent WM that can selectively delegate tasks to its non-relay subscribers based on their suitability. Analysis of the results from the FDE can be communicated to all downstream and upstream relays, as shown in system 700. This configuration allows a relay to preempt its own analysis tasks, instead forwarding any received Filter Objects directly to its subscribers and thus lowering the latency.

The WM can use a reinforcement learning-based decision model to continuously adapt analysis task assignment decisions based on observed performance feedback (e.g., completion time and network delay). Since new subscribers can join at any point during a live stream, their resource profiles are immediately integrated into the distribution process. If a subscriber fails or disconnects, the manager can automatically reassign its unfinished tasks to remaining subscribers.

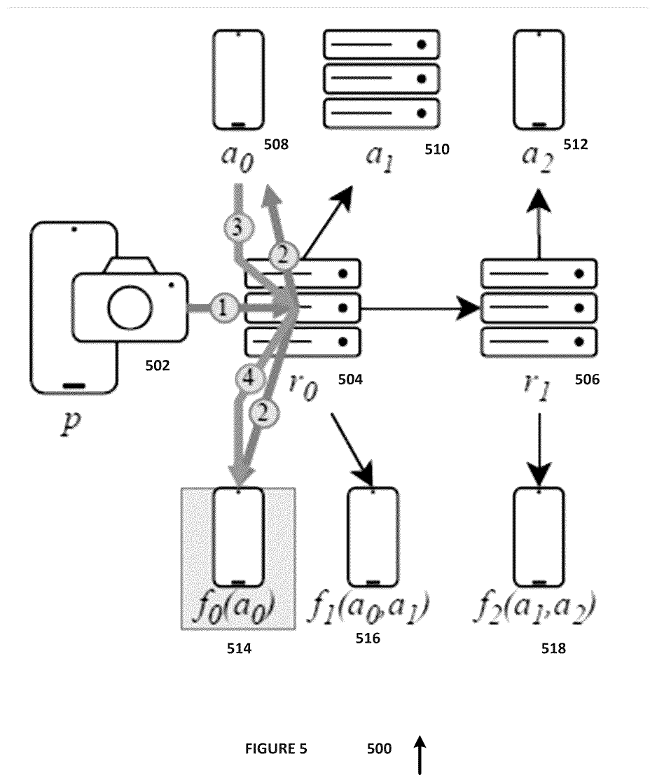

FIG. 5 is a diagram of a system 500 for processing image data at a second stage, in accordance with an example embodiment of the present disclosure. System 500 includes source 502, router 504, client 508, router 506, router 510, client 512, client 514, client 516, and client 518.

As shown in system 500, source 502 is the publisher p, nodes r₀ and r₁ are relays, nodes a₀, a₁ and a₂ are analyzer clients, and nodes for f₁ and f₂ are filter clients (with the selected filter categories noted in parentheses). Steps 1 through 4 are used to process video data at a and for as discussed further herein.

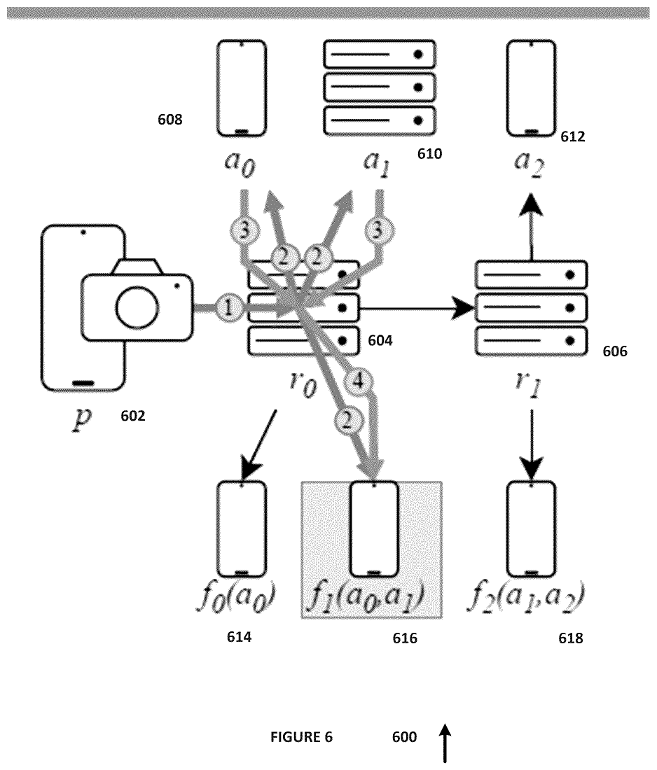

FIG. 6 is a diagram of a system 600 for processing image data at a third stage, in accordance with an example embodiment of the present disclosure. System 600 includes source 602, router 604, client 608, router 606, router 610, client 612, client 614, client 616, and client 618.

As shown in system 600, source 602 is the publisher p, nodes r₀ and r₁ are relays, nodes a₀, a₁ and a₂ are analyzer clients, and nodes f₀, f₁ and f₂ are filter clients (with the selected filter categories noted in parentheses). Steps 1 through 4 are used to process video data at a₀, a₁ and f₁ as discussed further herein.

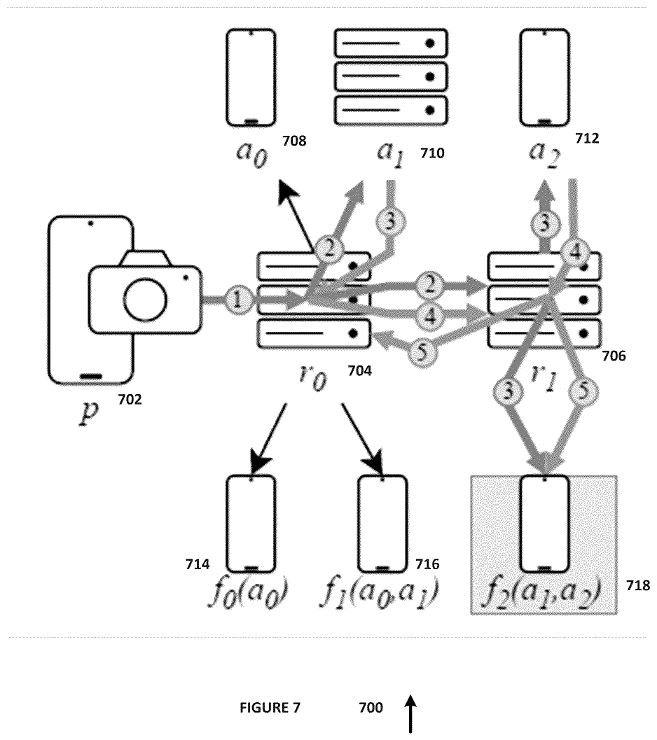

FIG. 7 is a diagram of a system 700 for processing image data at a fourth stage, in accordance with an example embodiment of the present disclosure. System 700 includes source 702, router 704, client 708, router 706, router 710, client 712, client 714, client 716, and client 718.

As shown in system 700, source 702 is the publisher p, nodes r₀ and r₁ are relays, nodes a₀, a₁ and a₂ are analyzer clients, and nodes for f₁ and f₂ are filter clients (with the selected filter categories noted in parentheses). Steps 1 through 5 are used to process video data at a₀, a₁ and a₂, r₀ and r₁ and f₂ as discussed further herein.

For the filter decision engine and security, as illustrated in systems 400 through 700, analyzer subscribers can be server devices rather than playback devices and can be used to run demanding applications or to minimize analysis latency. If only trusted servers are used as analyzers, the system can perform as-needed coordination of live moderation workloads over the media transport protocol. An alternate approach uses the relay to run all analyses itself, but risks the application starving the compute resources necessary for data transmission. Another alternative approach uses a separate protocol to send the video data to analysis servers, but moving and re-packaging the data between protocols would further add latency. The system can forward data within the MoQT protocol to external analysis servers with little overhead.

This approach can be used for performance reasons and to reduce provider costs by leveraging the computing capabilities of edge playback devices, thus decreasing the load on the proprietary components of the network. It is necessary to protect the system from security attacks if the edge devices are compromised. One attack could be malicious analyzers tricking the relay into making an incorrect decision to either flag acceptable content (thereby decreasing QoE) or by not flag objectionable content. Unlike the general consensus problem in distributed computing, in this case a correct decision should be reached independent of the vote of the participants. This architecture has an advantage over typical distributed algorithms in that a single mediator device (the relay) is known to not be malicious.

Different aspects of security exist for this architecture. In one case, it is assumed that malicious users have breached the internal security of an MoQ client and are able to send any kind of message (similar to the Byzantine Generals Problem). In the second case, other barriers must be defeated in order for a malicious user to achieve this level of access.

First, the FDE can determine the number of edge devices that are required to deliver an assumed level of security based on an assumed percentage of corrupted devices. Let A_{c}={a₀, a₁, . . . a₍ₙ₋₁₎} be the set of n devices that are analyzing a Frame Object for a given content category, c. Assume that A_{c}⊆S, where S is the set of all subscriber devices. If more than n/2 devices in A_{c} are secure, a simple majority protocol provides correct behavior. Given an assumed percentage of subscriber devices S are malicious, M, and an independent random sampling of subscribers to form A_{c}, the probability that the majority voting procedure yields the correct decision is the binomial probability that fewer than half of the chosen devices are malicious:

$$P r \{ k \leq ⌊ n / 2 ⌋ \} = {\sum }_{k = 0}^{k = ⌊ n / 2 ⌋} ( \begin{matrix}n \\ k\end{matrix} ) {{M}^{k} ( 1 - M )}^{n - k}$$

The probabilities of correct relay filter decision-making, at various analyzer counts |A_{c}| and malicious rates in Table 1

| Malicious Rate (M) | \|A\| = 3 | \|A\| = 5 | \|A\| = 7 | \|A\| = 9 |
|---|---|---|---|---|
| 0.01 | 0.972 | 0.991 | 0.997 | 0.999 |
| 0.25 | 0.843 | 0.896 | 0.929 | 0.951 |
| 0.50 | 0.5 | 0.5 | 0.5 | 0.5 |

Table 1 provides the probabilities that various sizes of analyzer sets will generate correct decisions with varying percentages of malicious users. This indicates that having a large set of analyzers does not produce significantly more accurate results. Thus, a set of 3 or 5 analyzers will be sufficient under low-to-moderate malicious rates (M<0.25).

Even though the simple majority is sufficient for realistic environments, it is always possible for a majority of responses to be malicious devices. When a vote is not unanimous, the FDE can send the stream to a trusted server-side analyzer. The FDE can use the response from the trusted source to perform two actions: (1) determine the true classification; or (2) replace the malicious devices (the ones that disagree with the trusted source) in the set A_{c}. Note that falling back to an internal analyzer will increase the delay from analysis, so it should only be used when malicious devices are detected. While this can reduce QoE if it creates a stall scenario, it greatly reduces the chances for incorrect behavior, as the malicious users could then corrupt the data only if every device in A_{c} is malicious. The probability for this event is Mk, meaning that even if 10% of the subscriber devices are malicious, a relay with 3 redundant and randomly selected analyzers selected will be compromised only 1 time in 1000.

Relay administrators can set a rate of analyzer redundancy (|A_{c}|) separately for each application based on a combination of business requirements, user preferences, and application semantics. For example, inaccurate decision-making for strobing light detection could cause serious health issues for PSE viewers. On the other hand, a failure to properly classify smoking activities will have less dire implications on users. Relay administrators must determine their own acceptable levels of risk.

One concern with the use of MoQ compared to HAS protocols is to minimize latency for live streaming. In the disclosed system, non-filtering subscribers can experience no additional latency even when analysis tasks are distributed in the network. To achieve this, the relays can set higher QUIC stream priorities for any non-filtering client. This configuration can minimize any potential latency impact from the WM, FDE, or Filter Object transmissions. Filtering clients, meanwhile, can experience some added latency, but can design strategies to minimize the latency impact under challenging scenarios, including network switches and analyzer failure.

To formally quantify latency, the following variables can be defined:
p: Publisher node
f: Filter subscriber node.
R: Set of Relay nodes.
A: Set of Analyzer clients across all content categories
L: The set of all dedicated analyzer-relay links, where each link l∈ [symbol] is a pair (r,a), r∈R, a∈A, and each a appears in exactly one pair.
t_{frame}(u,v): Latency of Frame Object transmission from u to v
tₘₑₜₐ(u,v): Latency of Filter Object transmission from u to v
t_{proc}(u): Processing latency at node u.
E_{relays}: Set of directed links between relays
   The worst-case scenario for latency in a multi-relay configuration shown in system 700 occurs when the Frame Object data has arrived at the last relay (the parent of a given filtering subscriber), but the FDE must wait for an analysis result (Filter Object) to propagate from the very first relay. If the transmission delay for Filter Objects is no greater than that of the associated Frame Objects at the same indices, then the maximum latency can be determined as follows:

$${L}_{total} = {t}_{frame} ( p , {r}_{first} ) + {max}_{( r , a ) ∈ ℒ} [ {t}_{frame} ( r , a ) ] + {max}_{a ∈ A} [ {t}_{p r o c} ( a ) ] + {max}_{( r , a ) ∈ ℒ} [ {t}_{meta} ( a , r ) ] + {Δ}_{relays} + {t}_{f r a m e} ( {r}_{last} , s )$$

$$Where : {Δ}_{relays} = {\sum }_{( u , v ) ∈ {E}_{relays}} {t}_{frame} ( u , v ) + {\sum }_{( u , v ) ∈ {E}_{relays}} {t}_{meta} ( u , v )$$

Filtering viewers might t find some amount of added latency tolerable, so long as it is consistent (e.g., 5 seconds further behind the live stream than their non-filtering counterparts). However, the system should avoid an increase in latency once the subscriber stream has begun, as this can cause playback stalls and hurt the QoE. The WMs can mitigate these risks by ensuring a high level of redundancy for each analysis application, and prioritizing low-latency clients for task delegation. A fail-safe can also be provided in the video player, such as if the analysis results have not arrived at the client within the playback latency budget (e.g., 1/30th of a second), then heavily blur and dim the decoded images (matching the most extreme possible filter actions).

To achieve this tight integration in practice, a filtering subscriber can be used to delay the display of its first Frame Object until the associated Filter Objects have been received. This mechanism sets the baseline latency budget for the rest of the streaming session, and allows the same client-driven adaptation algorithms that non-filtering clients will use to be leveraged. This approach is illustrated system 700, where a filtering client (f₂) can receive Frame Objects with minimal latency (timestep 3) like any other MoQ subscriber, but it may have to wait until the receipt of Filter Objects to display them (timestep 5). A benefit to this forced startup delay and a large playback is greater resilience under dramatic network changes that can increase packet jitter or loss.

Finally, some analysis applications may not be able to execute in real time on the available client devices. In these cases, the WM can shard analysis tasks between analyzers on a per-frame basis. Then, analyses for different Frame Objects can execute in parallel, and the added latency does not compound over time.

On one example embodiment, the moq library can be leveraged based on MoQ Transfork, which diverged slightly from the MoQT draft specification. That embodiment can also be adapted for the draft-compliant MOQtail library and implemented as discussed herein.

In another example embodiment, a prototype metadata schema can be used for conveying analysis results to filter clients. Filter categories benefit from a semantic priority order to determine which operation(s) the filter client should apply to the decoded frames. For example, the “block” action has a higher priority than “strong blur,” which has a higher priority than “moderate blur.” This hierarchy can be defined as a constant, such that frame blocking actions always supersede blurring actions.

In another example embodiment, edge client filtering operations can be used. A challenge is that modern web-based streaming systems often rely on the Media Source Extensions (MSE) API to offload containerized video decoding and rendering directly to the browser engine. To apply a full-image blur filter with MSE, the frame is applied to an HTML canvas element. Then, a CSS filter can be used to apply the blur operation. To blur only part of the image frame (i.e., a certain detected object), the draw function can be called twice. Although this adds some computational overhead, this approach can readily achieve real-time (120+ FPS) dynamic blurring during playback on a Pixel 7 Pro smartphone. Furthermore, if a non-containerized video format is streamed, the WebCodecs API can be leveraged to support direct manipulation of the pixel data to further reduce overhead.

Learning-based analysis applications can also or alternatively be used, such as by training a lightweight MobileNetV4 image classification model to perform smoking detection, achieving 120+ FPS performance with a dedicated GPU. For mobile client performance, 480p image classification can be performed on a Pixel 7 Pro smartphone at a minimum rate of 8 FPS. This approach underscores the need for sharding analysis task delegation between multiple devices if analyzer clients have limited compute power. More GPU-intensive applications, such as ViViT for multi-frame video classification, can require substantial GPU resources, so they will be practicable only on dedicated server-based analyzers or high-power viewer clients. For these non-deterministic applications, filter users can specify a minimum confidence threshold to set the tradeoff between the model accuracy and the user's personal tolerance to incorrect classifications. The FDE can determine its own threshold for how much the classification results are expected to vary between redundant clients (cf. 4.5) then average the confidence thresholds of the results for inclusion in the Filter Object metadata. Downstream filter clients can then accept or ignore these classifications based on the user-set confidence threshold.

The present disclosure can be extended to include audio analysis and filtering, for example to “bleep” profanity or increase classification accuracy with multimodal analysis. A full system implementation atop the MOQtail reference software can also or alternatively be used, as well as large-scale evaluations with a content delivery network deployment. To facilitate improvement and adoption, message wire formats and mandated component behaviors can be defined.

Systems and processes for distributed content-filtering architecture for live streaming are disclosed that leverage MoQ's stateful pub/sub transport to push per-frame results from analyzers and gate rendering at filter clients with minimal added latency. Metadata Tracks for filter decisions are disclosed, and multi-analyzer consolidation with a security-aware Filter Decision Engine is supported that outlines workflow management for analyzer selection and failover across multi-relay topologies. The present disclosure thus enables personalized moderation categories (e.g., strobe risk, violence, nudity, smoking) without bounded latency penalties for filtering clients, and no added latency for non-filtering clients.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for distributed data analysis and filtering, comprising:
a publisher system operating on a processor and configured to transmit a data stream comprising a plurality of groups of data to a relay system over a stateful transport protocol; and
the relay system operating on a processor and configured to receive the plurality of groups from the publisher, forward each group to one or more analyzer subscribers and selectively forward each group to one or more filtering subscribers based on one or more approval messages received from the one or more analyzer subscribers.

2. The system of claim 1 wherein each of the one or more analyzer subscribers operates on a processor and is configured to receive a group from the relay and to decode the group to obtain image data.

3. The system of claim 2 wherein each of the one or more analyzer subscribers is configured to perform content analysis on the image data to determine metadata identifying whether the group or frames of the group contain content associated with one or more content categories.

4. The system of claim 3 wherein each of the one or more analyzer subscribers is configured to transmit a message to the relay system indicating whether the group contains content for at least one of the one or more content categories.

5. The system of claim 1 wherein each of the one or more filtering subscribers operates on a processor and is configured to issue a subscription request to the relay specifying one or more content categories for which the filtering subscriber requests content filtering.

6. The system of claim 5 wherein each of the one or more filtering subscribers is configured to receive a group from the relay only after the relay has received the one or more approval messages indicating that the group has been approved for the one or more content categories specified by the filtering subscriber.

7. The system of claim 1 wherein the relay is further configured to deliver each group to non-filtering subscribers without waiting for an approval message, such that non-filtering subscribers experience no additional latency from content analysis and filtering.

8. The system of claim 5 wherein each of the one or more filtering subscribers receives metadata from one or more analyzer subscribers processes the data until subsequent metadata is received.

9. The system of claim 5 wherein one or more filter decision subscribers receives metadata from the one or more analyzer subscribers and processes the metadata for transmission to the relay system.

10. The system of claim 5 wherein one or more workflow management subscribers selects one or more analyzer subscribers to assign an analysis task as a function of one or more of a task demand, a subscriber availability, a subscriber connection status, a subscriber power, a subscriber battery profile, and a subscriber computational resource.

11. A method for distributed data content analysis and filtering, comprising:
transmitting a data stream comprising a plurality of groups of data to a relay system operating on a processor over a stateful transport protocol from a publisher system operating on a processor;
receiving the plurality of groups of data from the publisher at the relay system;
forwarding each group of data from the relay system to one or more analyzer subscribers;
selectively forwarding each group of data from the relay system to one or more filtering subscribers based on metadata received from the one or more analyzer subscribers; and
forwarding each group of data from the relay system to one or more filtering subscribers with metadata received from the one or more analyzer subscribers.

12. The method of claim 11 further comprising:
receiving a group from the relay at each of the one or more analyzer subscribers; and
decoding the group to obtain image data.

13. The method of claim 11 further comprising performing content analysis on the data stream at each of the one or more analyzer subscribers to determine metadata that identifies any groups that contain content associated with one or more content categories.

14. The method of claim 11 further comprising transmitting a measurement of content, where the metadata representing measurement is binary or non-binary for one or more content categories.

15. The method of claim 11 further comprising issuing a subscription request to the relay from each of the one or more filtering subscribers specifying one or more content categories for which the filtering subscriber requests content filtering.

16. The method of claim 12 further comprising receiving a group from the relay at each of the one or more filtering subscribers only after the relay has received one or more approval messages indicating that the group has been approved for one or more content categories specified by the filtering subscriber.

17. The method of claim 11 further comprising delivering each group to non-filtering subscribers from the relay without waiting for any approval message, such that non-filtering subscribers experience no additional latency from the content analysis and filtering.

18. The method of claim 14 further comprising receiving metadata from the one or more analyzer subscribers at one or more filter decision subscribers and processing the metadata for transmission to the relay system.

19. The method of claim 14 further comprising sending analysis task assignment data as a function of a task demand, a subscriber availability, a subscriber connection status, a subscriber power, a subscriber battery profile, and subscriber computational resources.

20. A system for distributed data analysis and filtering, comprising:
a publisher system operating on a processor and configured to transmit a data stream comprising a plurality of groups of data to a relay system over a stateful transport protocol; and
the relay system operating on a processor and configured to receive the plurality of groups from the publisher and to forward each group to one or more analyzer subscribers; and
one or more one or more analyzer subscribers configured to receive a group and transmit analysis results to the relay system, where the analysis results include metadata representing a task-dependent measurement for one or more content categories.
